(19) United States
(12) Patent Application Publication
(10) Pub. No.: US 2008/0211970 A1
(43) Pub. Date: Sep. 4, 2008

(54) TELEVISION RECEPTION CIRCUIT AND TELEVISION RECEPTION APPARATUS

(75) Inventors: Yasuo TAKESHITA, Osaka (JP); Takuya SUZUKA, Yawata-shi (JP); Hyoung Wook CHOI, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Osaka (JP); SANYO TUNER INDUSTRIES CO., LTD., Osaka (JP)

(21) Appl. No.: 12/033,411

(22) Filed: Feb. 19, 2008

(30) Foreign Application Priority Data
Feb. 20, 2007 (JP) 2007-038798

(51) Int. Cl. H04N 5/50

(52) U.S. Cl. 348/726; 348/E05.097

(57) ABSTRACT

A television reception circuit includes a high-frequency amplifier amplifying a received television signal, a mixer frequency-converting the amplified television signal to an intermediate-frequency signal, a filter attenuating a component outside a prescribed frequency band in the resultant intermediate-frequency signal, a first AGC circuit outputting a first gain control signal for setting a level of the intermediate-frequency signal output from the mixer to a prescribed value, a second AGC circuit outputting a second gain control signal for setting a level of the signal that has passed through the filter to a prescribed value, and a switch selecting any one of the first gain control signal and, the second gain control signal and outputting the selected gain control signal to the high-frequency amplifier, and the high-frequency amplifier amplifies the television signal with gain based on the gain control signal received from the switch.

### BACKGROUND OF THE INVENTION

1. Field of the Invention

The present invention relates to a television reception circuit for receiving a television signal and a television reception apparatus including the television reception circuit.

2. Description of the Background Art

For example, Japanese Patent Laying-Open Nos. 07-099614 and 2001-244836 disclose conventional television reception circuits.

In the television reception circuits described in Japanese Patent Laying-Open Nos. 07-099614 and 2001-244836, however, achieving a stable channel search operation and attaining excellent reception characteristics during normal reception has not been considered.

### SUMMARY OF THE INVENTION

An object of the present invention is to provide a television reception circuit and a television reception apparatus capable of achieving a stable channel search operation and attaining excellent reception characteristics during normal reception.

A television reception circuit according to one aspect of the present invention includes: a high-frequency amplifier amplifying a received television signal; a mixer frequency-converting the amplified television signal to an intermediate-frequency signal; a filter attenuating a component outside a prescribed frequency band in the resultant intermediate-frequency signal; a demodulator extracting a video signal from the signal that has passed through the filter; a first AGC circuit outputting a first gain control signal for setting a level of the intermediate-frequency signal output from the mixer to a prescribed value; a second AGC circuit outputting a second gain control signal for setting a level of the signal that has passed through the filter to a prescribed value; and a switch selecting any one of the first gain control signal and the second gain control signal and outputting the selected gain control signal to the high-frequency amplifier, and the high-frequency amplifier amplifies the television signal with gain based on the gain control signal received from the switch.

Preferably, during a channel search operation, the switch selects the first gain control signal, and during normal reception, the switch selects the second gain control signal.

Preferably, when an interference signal not lower than a prescribed level is contained in the signal output from the filter to the demodulator or the signal output from the demodulator, the switch selects the first gain control signal, and when the signal output from the filter to the demodulator is not higher than a prescribed level, the switch selects the second gain control signal.

A television reception apparatus according to one aspect of the present invention includes: a high-frequency amplifier amplifying a received television signal; a mixer frequency-converting the amplified television signal to an intermediate-frequency signal; a filter attenuating a component outside a prescribed frequency band in the resultant intermediate-frequency signal; a demodulator extracting a video signal from the signal that has passed through the filter; a signal processing circuit subjecting the extracted video signal to prescribed signal processing; a first AGC circuit outputting a first gain control signal for setting a level of the intermediate-frequency signal output from the mixer to a prescribed value; a second AGC circuit outputting a second gain control signal for setting a level of the signal that has passed through the filter to a prescribed value; and a switch selecting any one of the first gain control signal and the second gain control signal and outputting the selected gain control signal to the high-frequency amplifier, and the high-frequency amplifier amplifies the television signal with gain based on the gain control signal received from the switch.

Preferably, during a channel search operation, the switch selects the first gain control signal, and during normal reception, the switch selects the second gain control signal.

Preferably, when an interference signal not lower than a prescribed level is contained in the signal output from the filter to the demodulator or the signal output from the demodulator, the switch selects the first gain control signal, and when the signal output from the filter to the demodulator is not higher than a prescribed level, the switch selects the second gain control signal.

According to the present invention, a stable channel search operation can be achieved and excellent reception characteristics can be attained during normal reception.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 are block diagrams of a television reception circuit according to an embodiment of the present invention.

FIG. 3 is a block diagram of a television reception apparatus according to an embodiment of the present invention.

### DESCRIPTION OF THE PREFERRED EMBODIMENTS

An embodiment of the present invention will be described hereinafter with reference to the drawings. In the drawings, the same or corresponding elements have the same reference characters allotted, and detailed description thereof will not be repeated.

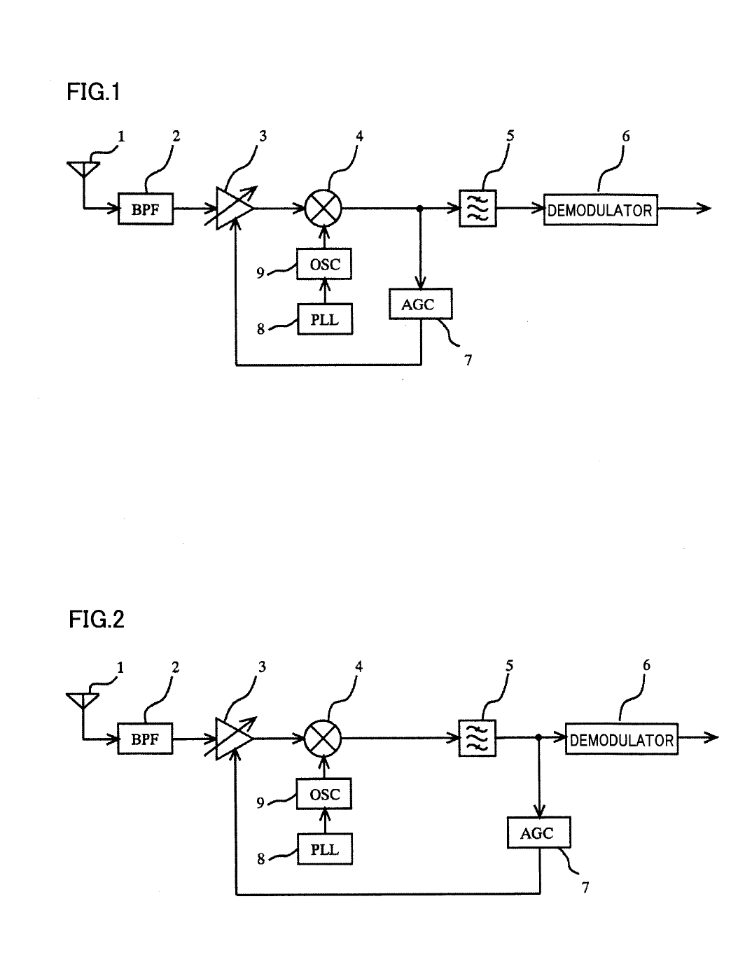

FIG. 1 is a block diagram showing a configuration of a television reception circuit according to an embodiment of the present invention.

A television reception circuit shown in FIG. 1 includes a BPF (Band Pass Filter) 2 allowing passage of only a component not higher than a prescribed frequency in a television signal received by an antenna 1, a high-frequency amplifier 3 amplifying the signal output from BPF 2, an AGC (Automatic Gain Control) circuit 7 outputting a gain control signal for controlling gain of high-frequency amplifier 3, a mixer 4 frequency-converting the amplified signal to an intermediate-frequency signal, an SAW (Surface Acoustic Wave) filter 5 obtaining a signal in a necessary frequency band from the intermediate-frequency signal frequency-converted by mixer 4, that is, attenuating a component outside a prescribed frequency band in frequency components of the intermediate-frequency signal, and a demodulator 6 extracting a video signal from the signal that has passed through SAW filter 5 and detecting a synchronous signal contained in the video signal.

In addition, the television reception circuit shown in FIG. 1 includes a PLL (Phase Locked Loop) circuit 8 and an OSC (Oscillator) circuit 9 for frequency-conversion of a television signal in a frequency band corresponding to a channel selected for viewing (hereinafter also referred to as a selected channel) to a signal in an intermediate frequency band. PLL circuit 8 and OSC circuit 9 generate a local oscillation signal to be output to mixer 4 together with the television signal.

PLL circuit 8 outputs a frequency-controlling voltage to OSC circuit 9 so that OSC circuit 9 oscillates at a desired local oscillation frequency. PLL circuit 8 generates a signal having a reference frequency (for example, equal to the local oscillation frequency) based on externally provided frequency data.

Thus, the television reception circuit shown in FIG. 1 adopts, as a method of outputting a gain control signal for controlling gain of high-frequency amplifier 3, a first method in which AGC circuit 7 outputs a gain control signal for setting a level of the intermediate-frequency signal output from mixer 4 to a prescribed value.

FIG. 2 is a block diagram showing a configuration of a television reception circuit according to an embodiment of the present invention.

The television reception circuit shown in FIG. 2 adopts a second method in which AGC circuit 7 outputs a gain control signal for setting a level of the signal output from SAW filter 5 to a prescribed value.

According to the first method, however, if any interference signal outside the frequency band corresponding to the selected channel is present, AGC circuit 7 is not able to make distinction between the television signal corresponding to the selected channel and the interference signal. Accordingly, as it becomes difficult to maintain the level of the television signal corresponding to the selected channel at a desired value, reception characteristics such as reception sensitivity and S/N ratio (Signal to Noise Ratio) may deteriorate.

On the other hand, according to the second method, as the television signal from which the interference signal has been eliminated by SAW filter 5 is output to AGC circuit 7, the level of the television signal corresponding to the selected channel can be maintained at a desired value regardless of presence/absence of the interference signal and excellent television reception characteristic can be attained.

If a television signal corresponding to a selected channel is absent but a television signal corresponding to a channel that has not been selected (hereinafter also referred to as a non-selected channel) is present in the signal output from mixer 4, AGC circuit 7 attempts to increase gain of high-frequency amplifier 3 up to as high as maximum in order to raise the level of the television signal corresponding to the selected channel up to a prescribed value. Then, the television signal at a high level corresponding to the non-selected channel is output to mixer 4, which results in distortion. In addition, if SAW filter 5 cannot completely eliminate the television signal corresponding to the non-selected channel due to too high a level of the signal output from mixer 4, the television signal corresponding to the non-selected channel is output to demodulator 6. Then, demodulator 6 extracts an erroneous video signal owing to the television signal corresponding to the non-selected channel and detects a signal synchronous to the extracted video signal. Namely, during the channel search operation, despite the fact that the television signal corresponding to the selected channel is absent, the television reception circuit erroneously determines that a desired television signal is present in the received frequency band, due to influence of the television signal corresponding to the non-selected channel or the like.

A television reception circuit solving a problem in each of the first and second methods above will now be described.

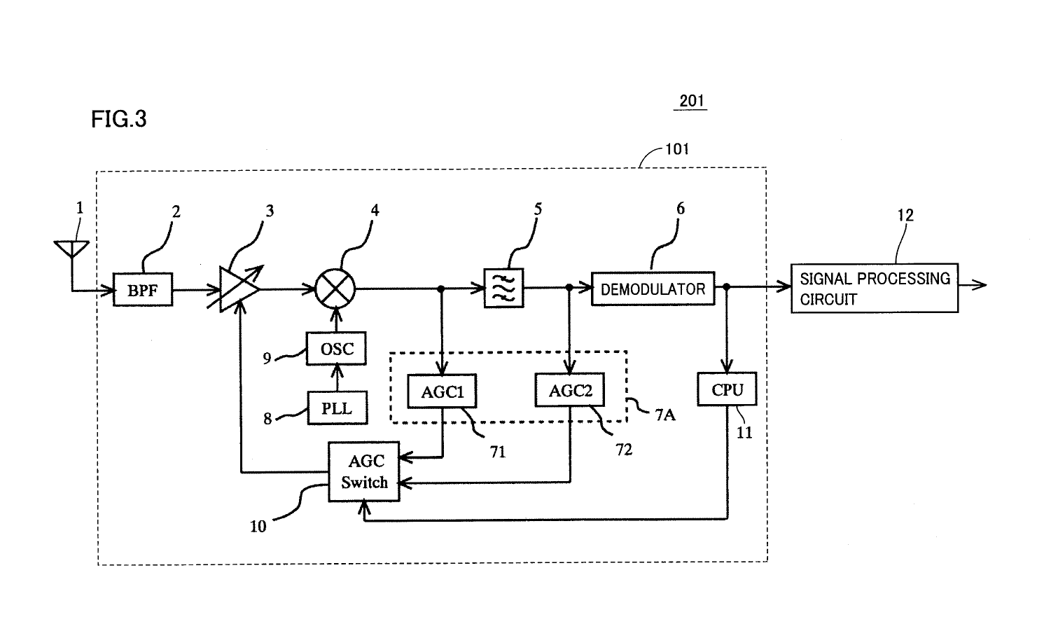

FIG. 3 is a block diagram showing a configuration of a television reception apparatus according to an embodiment of the present invention.

Referring to FIG. 3, a television reception apparatus 201 includes antenna 1, a television reception circuit 101, and a signal processing circuit 12. Television reception circuit 101 includes BPF 2 allowing passage of only a component not higher than a prescribed frequency in a television signal received by antenna 1, high-frequency amplifier 3 amplifying the signal output from BPF 2, an AGC circuit portion 7A outputting a gain control signal for controlling gain of high-frequency amplifier 3, mixer 4 frequency-converting the amplified signal to an intermediate-frequency signal, SAW filter 5 obtaining a signal in a necessary frequency band from the intermediate-frequency signal frequency-converted by mixer 4, that is, attenuating a component outside a prescribed frequency band in frequency components of the intermediate-frequency signal, and demodulator 6 extracting a video signal from the signal that has passed through SAW filter 5 and detecting a synchronous signal contained in the video signal. Signal processing circuit 12 subjects the video signal and the like received from demodulator 6 to prescribed signal processing.

In addition, PLL circuit 8 and OSC circuit 9 for frequency-conversion of a television signal in a frequency band corresponding to a selected channel to a signal in an intermediate frequency band are provided. PLL circuit 8 and OSC circuit 9 generate a local oscillation signal to be output to mixer 4 together with the television signal.

PLL circuit 8 outputs a frequency-controlling voltage to OSC circuit 9 so that OSC circuit 9 oscillates at a desired local oscillation frequency. PLL circuit 8 generates a signal having a reference frequency (for example, equal to the local oscillation frequency) based on externally provided frequency data.

AGC circuit portion 7A includes a first AGC circuit 71 outputting a first gain control signal for setting a level of the intermediate-frequency signal output from mixer 4 to a prescribed value and a second AGC circuit 72 outputting a second gain control signal for setting a level of the intermediate-frequency signal output from SAW filter 5 to a prescribed value.

The first and second gain control signals are output to an AGC Switch 10. In addition, a CPU 11 determines whether the current state of television reception apparatus 201 indicates a channel search operation or normal reception, based on the signal received from demodulator 6. Then, CPU 11 outputs an AGC switching signal to AGC Switch 10 based on the result of determination.

AGC Switch 10 selects any one of the first gain control signal and the second gain control signal based on the AGC switching signal received from CPU 11. Specifically, AGC Switch 10 selects the first gain control signal during the channel search operation and selects the second gain control signal during normal reception, and outputs the selected gain control signal to high-frequency amplifier 3.

High-frequency amplifier 3 amplifies the television signal with gain based on the gain control signal received from AGC Switch 10.

With the configuration above, during channel search, only presence of a desired wave can reliably be detected without erroneously detecting an interference wave such as a television signal corresponding to an adjacent channel and the like, and thus a stable channel search operation can be achieved. In addition, during normal reception, a signal level of a desired wave can always be maintained constant regardless of presence/absence of an interference wave, and excellent reception characteristics can be attained.

In the television reception circuit according to the embodiment of the present invention, CPU 11 determines whether the current state of television reception apparatus 201 indicates the channel search operation or normal reception based on the signal received from demodulator 6. Then, CPU 11 outputs an AGC switching signal to AGC Switch 10 based on the result of determination. Here, a method of selecting the AGC switching signal to be output to AGC Switch 10 is not limited as such.

For example, the configuration may be such that, if CPU 11 determines that an interference signal not lower than a prescribed level is contained based on the signal output from SAW filter 5 to demodulator 6 or the signal output from demodulator 6, the AGC switching signal having AGC Switch 10 select the first gain control signal is output to AGC Switch 10. Alternatively, the configuration may be such that, if CPU 11 determines that the signal output from SAW filter 5 to demodulator 6 is not higher than a prescribed level, the AGC switching signal having AGC Switch 10 select the second gain control signal is output to AGC Switch 10.

With the configuration above, for example, if a level of an interference wave is high due to presence of a neighboring channel, a reflected wave from a building, thunder, and the like, the first gain control signal is output to high-frequency amplifier 3. Alternatively, for example, if received electric field is weak, the second gain control signal is output to high-frequency amplifier 3. Namely, deterioration in reception quality caused by the interference wave can be prevented and sensitivity to weak electric field can also be maintained at the best condition. Therefore, regardless of the state of the television signal received by the antenna, a stable channel search operation can be achieved and excellent reception characteristics can be attained during normal reception.

The SAW filter is used for obtaining an intermediate-frequency signal in a frequency band corresponding to a selected channel from the intermediate-frequency signal frequency-converted by mixer 4, however, any filter having a function to allow passage of a signal in a prescribed frequency band may be employed, without limited to the SAW filter.

In addition, by providing television reception circuit 101 in television reception apparatus 201 such as a portable telephone terminal, a stable channel search operation can be achieved also in television reception apparatus 201 and excellent reception characteristics can be attained during normal reception.

Moreover, CPU 11 is provided in television reception circuit 101 in the embodiment of the present invention, however, CPU 11 may naturally be provided in television reception apparatus 201.

Although the present invention has been described and illustrated in detail, it is clearly understood that the same is by way of illustration and example only and is not to be taken by way of limitation, the scope of the present invention being limited only by the terms of the appended claims.

What is claimed is:

1. A television reception circuit comprising:
a high-frequency amplifier amplifying a received television signal;
a mixer frequency-converting amplified said television signal to an intermediate-frequency signal;
a filter attenuating a component outside a prescribed frequency band in resultant said intermediate-frequency signal;
a demodulator extracting a video signal from the signal that has passed through said filter;
a first AGC circuit outputting a first gain control signal for setting a level of said intermediate-frequency signal output from said mixer to a prescribed value;
a second AGC circuit outputting a second gain control signal for setting a level of the signal that has passed through said filter to a prescribed value; and
a switch selecting any one of said first gain control signal and said second gain control signal and outputting the selected gain control signal to said high-frequency amplifier;
said high-frequency amplifier amplifying said television signal with gain based on said gain control signal received from said switch.

2. The television reception circuit according to claim 1, wherein
during a channel search operation, said switch selects said first gain control signal, and during normal reception, said switch selects said second gain control signal.

3. The television reception circuit according to claim 1, wherein
when an interference signal not lower than a prescribed level is contained in the signal output from said filter to said demodulator or the signal output from said demodulator, said switch selects said first gain control signal, and when the signal output from said filter to said demodulator is not higher than a prescribed level, said switch selects said second gain control signal.

4. A television reception apparatus, comprising:
a high-frequency amplifier amplifying a received television signal;
a mixer frequency-converting amplified said television signal to an intermediate-frequency signal;
a filter attenuating a component outside a prescribed frequency band in resultant said intermediate-frequency signal;
a demodulator extracting a video signal from the signal that has passed through said filter;
a signal processing circuit subjecting said extracted video signal to prescribed signal processing;
a first AGC circuit outputting a first gain control signal for setting a level of said intermediate-frequency signal output from said mixer to a prescribed value;
a second AGC circuit outputting a second gain control signal for setting a level of the signal that has passed through said filter to a prescribed value; and
a switch selecting any one of said first gain control signal and said second gain control signal and outputting the selected gain control signal to said high-frequency amplifier;
said high-frequency amplifier amplifying said television signal with gain based on said gain control signal received from said switch.

5. The television reception apparatus according to claim 4, wherein
during a channel search operation, said switch selects said first gain control signal, and during normal reception, said switch selects said second gain control signal.

6. The television reception apparatus according to claim 4, wherein
when an interference signal not lower than a prescribed level is contained in the signal output from said filter to said demodulator or the signal output from said demodulator, said switch selects said first gain control signal, and when the signal output from said filter to said demodulator is not higher than a prescribed level, said switch selects said second gain control signal.
